(19) United States
(12) Patent Application Publication
(10) Pub. No.: US 2007/0138719 A1
(43) Pub. Date: Jun. 21, 2007

(54) Fluid-filled type active vibration damping device

(75) Inventors: Hiroyuki Ichikawa, Kani-shi (JP); Takayoshi Yasuda, Iwakura-shi (JP); Yoshinori Watanabe, Komaki-shi (JP); Motoshi Sakurai, Ama-gun (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., KOMAKI-SHI (JP)

(21) Appl. No.: 11/640,843

(22) Filed: Dec. 19, 2006

(30) Foreign Application Priority Data
Dec. 21, 2005 (JP) 2005-367893

(51) Int. Cl. F16F 13/00

(52) U.S. Cl. 267/140.14; 267/140.13

(57) ABSTRACT

A fluid-filled active vibration damping device wherein a solenoid actuator designed with a movable element positioned inserted into a guide hole of a stator having a yoke member is attached about a coil to form a stator-side magnetic path with the guide hole lying on its center axis, so that current passed through the coil creates actuating force in an axial direction between the stator and the movable element. A bias urging assembly is disposed for urging the movable element in one axis-perpendicular direction to the stator. A plastic deformation member disposed between opposing faces of the movable element and the oscillation member, and is adapted to be deformed in a plastic deformation region exceeding an elastic deformation domain so as to define approaching ends of the movable element and the oscillation member in a mutually approaching direction.

### INCORPORATED BY REFERENCE

The disclosure of Japanese Patent Application No. 2005-367893 filed on Dec. 21, 2005 including the specification, drawings and abstract is incorporated herein by reference in its entirety.

### BACKGROUND OF THE INVENTION

1. Field of the Invention

The present invention relates in general to a fluid filled active vibration damping device capable of exhibiting active vibration damping device by controlling fluid pressure fluctuation in a pressure-receiving chamber having a non-compressible fluid sealed therein at a period corresponding to a frequency of target vibration. More specifically, the present invention is concerned with a fluid filled type active vibration damping device wherein an electromagnetic actuator is employed by controlling the fluctuation in the pressure receiving chamber.

2. Description of the Related Art

A fluid filled active vibration damping device are known as one kind of vibration damping coupling or mount to be installed between components that are desired to be damped, such as an automotive engine mount or body mount, to provide vibration damped coupling between the components. A damping apparatus of this kind typically has a construction wherein a first mounting member and a second mounting member connected to one another by a rubber elastic body are respectively attached to the components to be coupled in vibration damping fashion, and comprising a pressure-receiving chamber a portion of whose wall is constituted by the rubber elastic body, and having a non-compressible fluid sealed therein. An excitation plate constitutes another portion of the wall of the pressure-receiving chamber, and is movable by means of an actuator. A fluid pressure in the pressure-receiving chamber is actively controlled by applying excitation force corresponding to the vibration to be damped against the excitation plate, thereby exhibiting vibration damping effect against vibration to be damped in an offset or active manner.

In fluid filled type active vibration damping devices of this kind, in order to achieve effective damping action, it is important to control pressure fluctuations within the pressure-receiving chamber to frequency and phase corresponding with high accuracy to input vibration.

The actuator used to apply actuating force to the oscillation member is favorably a solenoid type actuator. Such an actuator typically has a structure wherein a movable member is positioned displaceably inserted in a stator having a yoke member attached about a coil to form a magnetic path, and current is passed through the coil to create actuating force in the axial direction between the stator and the movable element.

In the event that a solenoid actuator of this kind is to be employed, for example, in an automotive engine mount or other vibration damping device, there is a problem in that the actuator, and hence the vibration damping device itself, may not readily afford satisfactory durability and reliability with regard to operating performance. Namely, in the case of an automotive engine mount, it is necessary for the device to be able to provide continuous vibration damping for a predetermined time period in a high frequency range of several tens of Hz and above for an extended time of several years or more. A typical solenoid actuator cannot consistently maintain such continuous operation in a high frequency range for an extended period.

Namely, a gap formed between opposite faces of the movable member and the stator in the axis-perpendicular direction is made relatively tiny overall in order to provide output of the actuator efficiently. Therefore, if the movable member undergoes tilting displacement in the twisting or prizing direction relative to the stator, the movable member may possibly comes into contact with the stator, resulting in the problem of damages of these two members due to the contact. In the vibration damping device in particularly, while a rubber elastic body is used to support the excitation plate connected to the movable member in a movable manner, since the rubber elastic body experiences a molding shrinkage, it is impossible for the rubber elastic body to provide dimensional precision as accuracy as the metallic member does. Further, due to positional errors between components of the vibration-damping device during assembly, the stator and the movable member may suffer from positional errors relative to each other. Accordingly, it is difficult to avoid the slant of the movable member fixed to the oscillation member relative to the stator adapted to be fixed to the second mounting member, leading to unavoidable occurrence of the contact between the stator and the movable member due to the slant of the movable member.

While the slant of the movable member causes the contact between the stator and the movable member in the axis-perpendicular direction, in many cases it occurs as a point contact of the upper or lower end of the movable member against the stator. This results in an increase of a contact pressure between the contact portions of the movable member and the stator increases, accelerating rubbing of the contact point. This makes it difficult to ensure a sufficient durability and to obtain stable operation characteristics of the vibration-damping device.

To cope with the above mentioned problem, U.S. Pat. No. 6,422,546 discloses a fluid-filled type active vibration-damping device proposed in an effort to prevent the slant of the movable member relative to the stator as one object, wherein the oscillation member is elastically connected at a connecting portion against the movable member in a tiltable manner with the connecting portion being tiltable with respect to the stator.

However, in the device disclosed in U.S. Pat. No. 6,422,546, the elastic connecting portion is disposed on a path of transmission of the excitation force produced by the axial displacement of the movable member to the excitation plate, so that erroneous arrangement of the spring properties in the elastic connecting portion will cause bowing of the oscillation member. This results in undesirable transmission efficiency of the excitation force to the excitation plate, needing increased power consumption in order to achieve desired vibration damping effect. Further, several changes will occur on the rubber elastic body for elastically supporting the oscillation member due to the fluid pressure fluctuation. This several changes of the rubber elastic body concurred with the bowing of the oscillation member may possibly cause deterioration in durability of the rubber elastic body. On the other hand, if the elastic connecting portion is formed of a sufficiently rigid material, bowing or tilting of the connecting portion cannot be readily permitted, possibly making it difficult to effectively prevent tilt of the movable member against the stator. In short, there is an outstanding object, namely it is difficult to set up spring characteristics of the elastically connecting portion or the like, when the connecting portion is of construction tiltable while assuring efficient transmission of the excitation plate and the sufficient durability of the connecting portion.

### SUMMARY OF THE INVENTION

It is an object of the present invention to provide a fluid filled type active vibration damping device of novel construction, capable of concurrently ensuring a sufficient transmission efficiency of the excitation force, durability and reliability of the device, while assuring stable operation of the movable member and the stator in the solenoid actuator.

The above and/or optional objects of this invention may be attained according to at least one of the following aspects of the invention. The following aspects and/or elements employed in each aspect of the invention may be adopted at any possible optional combinations. It is to be understood that the principle of the invention is not limited to these aspects of the invention and combinations of the technical features, but may otherwise be recognized based on the teachings of the present invention disclosed in the entire specification and drawings or that may be recognized by those skilled in the art in the light of the present disclosure in its entirety.

One aspect of the invention provides a fluid-filled type active vibration damping device comprising: a first mounting member and a second mounting member, the members attachable respectively to components linked to each other to make up a vibration transmission system; a main rubber elastic body elastically connecting the first and second mounting members, defining one portion of a wall of a pressure-receiving chamber having a non-compressible fluid sealed therein; an oscillation member defining another portion of the wall of the pressure receiving chamber; a solenoid actuator including a stator having a coil and a yoke member attached about the coil to form a stator-side magnetic path with a guide hole extending along a center axis thereof, and a movable element positioned inserted into the guide hole of the stator so that actuating force in an axial direction is created between the stator and the movable element by means of supplying electrical current to the coil, the stator of the solenoid actuator being affixed to the second mounting member and the movable element being attached to the oscillation member so as to actively control pressure in the pressure-receiving chamber by exciting actuation of the oscillation member; a bias urging assembly for urging the movable element in one direction orthogonal to a center axis with respect to the stator; a connecting shaft for connecting the movable element and the oscillation member while permitting their relative displacement in an axis-perpendicular direction; a positioning mechanism for pressing and positioning the movable element and the oscillation member relative to each other in a mutually approaching direction in an axial direction of the connecting shaft; and a plastic deformation member disposed between opposing faces of the movable element and the oscillation member, and being adapted to be deformed in a plastic deformation region exceeding an elastic deformation domain so as to define approaching ends of the movable element and the oscillation member in the mutually approaching direction so that the plastic deformation member in cooperation with the positioning mechanism fixedly position the movable element with respect to the oscillation member in the axial direction.

In the fluid-filled active vibration damping device constructed in accordance with this mode, by employing the bias urging assembly to urge the movable element to one side in the axis-perpendicular direction, it is possible to suppress tilt of the movable element with respect to the stator. With this arrangement, it is possible to avoid the conventional problem of the upper and lower ends of the movable element becoming biased in the axis-perpendicular direction so as to come into point contact against the inner peripheral face of the guide hole of the stator, thereby preventing an increase in localized contact pressure or sticking of the movable element against the stator so that smooth operation is realized.

Additionally, by more actively subjecting the movable element to urging force to one side in the axis-perpendicular direction, the movable element can be brought into contact with the stator with more wider contact area as well as stability. This makes it possible to minimize or avoid low durability due to increased contact pressure and unstable operation due to sticking of the movable element against the stator.

Further, the plastic deformation member is axially interposed between the oscillation member and the movable element with the plastic deformation member plastically deformed in the axial direction in advance, thereby preventing or limiting additional axial deformation of the plastic deformation member. That is, by means of the plastically deformed plastic deformation member, the oscillation member and the movable element can be effectively positioned in the mutually approaching direction on their center axis. With this arrangement, a sufficient transmission efficiency of the excitation force to the oscillation member can be achieved, thereby ensuring desired vibration damping effect.

Yet further, even in the case where the oscillation member is subjected to the external force in the twisting direction, since the plastic deformation member has been plastically deformed so as not to be deformed further easily, the inclining deformation between the oscillation member and the movable element from their initial states can be prevented. This arrangement prevents damages of the oscillation member and the movable element due to their contacts, leading to improved durability of the device.

In addition, the inclination of the movable element with respect to the stator is prevented by means of the bias urging assembly, while the movable element is positioned to the oscillation member in the twisting direction by means of the plastic deformation member and the positioning mechanism. Thus, even in the case where the external force in the twisting direction is applied to the oscillation member, the inclination of the oscillation member to the movable element as well as the inclination of the movable element to the stator can be effectively prevented. By means of this arrangement, the desired oscillation force can be applied to the pressure-receiving chamber effectively, and there is achieved durability of device and the stability in the oscillation motion.

Preferably, the bias urging assembly comprises a magnetic force biasing mechanism for biasing to one side in the axis-perpendicular direction a resultant force of magnetic forces excited in the axis-perpendicular direction between the movable element and the stator, by means of supplying electrical current to the coil. With this arrangement, the bias urging assembly can be realized by effectively utilizing magnetic force generated by the solenoid actuator. Thus, the desired bias urging assembly can be realized with the reduced number of components and simple structure.

In the further preferred practice, an annular magnetic pole portion is formed on an inner peripheral portion of the stator so as to extend over an entire circumference thereof, and an annular magnetic action part is formed on an outer peripheral portion of the movable element so as to extend over an entire circumference thereof, while being opposite to the annular magnetic pole portion of the stator with a gap therebetween both in axial and diametrical direction, and wherein the magnetic force biasing mechanism is realized by varying in a circumferential direction a distance between the magnetic pole portion and the magnetic action part. According to this arrangement, the magnetic force applied between the stator and the movable member can be effectively varied in the circumferential direction without needing significant design changes of the stator and the movable elements, thereby readily providing the magnetic force biasing mechanism.

In the yet further preferred practice, the movable element has an outer circumferential surface of cylindrical shape, and an annular edge portion of rectangular shape in cross section extends over an entire circumference on a plane slant to a plane orthogonal to a center axis of the outer circumferential surface of the movable element so that the magnetic action part is formed by means of the annular edge portion. With this arrangement, the edge portion is adapted to mainly affected by the magnetic force applied between the stator and the movable element, and is formed to be inclined with respect to the plane extending in the axis-perpendicular direction, whereby the axial distance between the magnetic pole portion and the magnetic action part varies in the circumferential direction. Thus, the magnetic force biasing mechanism can be realized with a simple construction.

Preferably, the annular edge portion may be effectively formed by utilizing an opening edge of a side wall of the rectangular groove open in the outer circumferential surface of the movable element while extending over an entire circumference. Alternatively, the annular edge portion may be effectively formed by shaping one axial end face of the movable element to be inclined with respect to the axis-perpendicular face by a given angle. Yet further, the annular edge portion may be effectively formed by utilizing an outer edge portion of an annular stepped portion formed on the outer circumferential surface of the movable element so as to be inclined with respect to the axis-perpendicular face.

In another preferred practice, the movable element has a through hole perforating therethrough in the axial direction, and the connecting shaft extends through the through hole while being fixed at one axial end thereof to the oscillation member, and being formed with a bolt thread at an other axial end thereof, while a positioning nut is threaded onto the bolt thread of the connecting shaft so that the positioning mechanism is realized by means of tightening up the positioning nut against the movable element. According to this preferred practice, by tightening up the positioning nut onto the bolt thread of the connecting shaft, the connecting shaft is assembled with a state of being movable relative to the movable element in the axis-perpendicular direction, and the movable element and the oscillation member are forcedly pressed to each other in the axial direction.

In yet another preferred practice, a tubular spacer member that is axially superposed against the plastic deformation member, and together with the plastic deformation member is disposed radially outward of the connecting shaft, while being interposed between the opposing faces of the oscillation member and the movable element. This arrangement makes it readily possible to change or adjust the axial distance between the oscillation member and the movable element in comparison with the case of the design change of the plastic deformation member.

In yet another preferred practice, the plastic deformation member is of an annular plate shape extending in the axis-perpendicular direction, and includes a top wall portion externally fitted on the connecting shaft and a plurality of inclined legs located on respective circumferential positions of the top wall portion while extending from an outer rim of the top wall portion toward axially one side with an inclination in an diagonally outward direction, the plastic deformation member undergoing plastic deformation at the inclined legs. With this arrangement, the plastic deformation member has been plastically deformed at their inclined legs extending in the inclined diametrically outward direction or in the diagonally outward direction. Thus, the plastic deformation member can be readily deformed plastically in the axial direction, while effectively preventing an inclination of the plastic deformation member with respect to the axial direction. Moreover, since the plastic deformation member is arranged to be plastically deformed at the inclined legs, the top wall portion is able to realize the desired rigidity. Thus, the axial positioning between the movable element and the oscillation member can be realized with sufficient rigidity and with sufficient stability.

Preferably, a distal end portion of each inclined leg turns up in the diametrically outward direction with a curved shape so as to provide an abutting end face. With this arrangement, a projecting edge of each inclined leg is held in a non-contact state with respect to the axially opposing faces of the oscillation member or the movable element to which the inclined leg is brought into abutting contact, thereby effectively avoiding damages of the oscillation member and the movable element by means of the inclined legs.

In still another preferred practice, the plastic deformation member further includes a positioning tubular portion extending in the axial direction from an inner rim of the top wall portion thereof so that the plastic deformation member is externally fitted on the connecting shaft at the positioning tubular portion. With this arrangement, the positioning tubular portion is effective to prevent inclination of the plastic deformation member with respect to the connecting rod, thereby effectively ensuring stable plastic deformation of the plastic deformation member in the axial direction.

In yet another preferred practice, the plastic deformation member further includes a plurality of stopper legs located on respective circumferential positions of the top wall portion circumferentially interposed between adjacent ones of the inclined legs while extending from the outer rim of the top wall portion toward a same axially one side as the inclined legs parallel to the center axis. By the presence of the stopper legs, the amount of plastic deformation of the inclined legs is limited, and the movable element and the oscillation member is connected with high rigidity in the axial direction, while allowing relative displacement in the axis-perpendicular direction between the inclined legs and the movable element. Like the inclined legs, preferably, a distal end portion of each inclined leg turns up in the diametrically outward direction with a curved shape so as to provide an abutting end face. With this arrangement, even if the stopper legs are held in abutting contact with the axially opposing faces of the oscillation member or the movable element, a projecting edge of each inclined leg is remote from the axially opposing faces of the oscillation member or the movable element, thereby effectively avoiding damages of the oscillation member and the movable element by means of the stopper legs.

As will be understood from the aforementioned description, the plastic deformation member is not necessarily to be plastically deformable over an entire area thereof. For instance, it may be partially deformable, while being partially undeformable to form a positioning mechanism for positioning the oscillation member and the movable element in the axially approaching direction.

It is preferably to form three or more inclined legs and three or more stopper legs while being evenly arranged in the circumferential direction by turn. This arrangement is effective to prevent inclination of the plastic deformation member when it comes into abutting contact with the oscillation member and the movable element. Also with this arrangement, the pressing force is evenly exerted on the inclined legs, thereby creating stable deformation state of the plastic deformation member.

In yet another preferred practice, the oscillation member has a hollow cylindrical shape with bottom, and a support rubber elastic body is bonded on an outer circumferential surface of the oscillation member so that the oscillation member is supported by the support rubber elastic body in a displaceable manner relative to the second mounting member in the axial direction, while an open end edge of the oscillation member is bent toward the outer circumferential surface with a roll shape. While burrs may possible be formed on the open end edge of the oscillation member, this arrangement is effective to prevent cracking or other drawbacks occurred in a local portion of the support rubber elastic body where is fixed to the open end edge of the oscillation member.

### BRIEF DESCRIPTION OF THE DRAWINGS

The foregoing and/or other objects features and advantages of the invention will become more apparent from the following description of preferred embodiments with reference to the accompanying drawings in which like reference numerals designate like elements and wherein:

FIG. 1 is an elevational view in axial or vertical cross section of a fluid filled type active vibration-damping device in the form of an automotive engine mount of construction according to a first embodiment of the present invention;

FIG. 2 is a transverse cross sectional view of an electromagnetic actuator of the engine mount of the invention, taken along line 2-2 of FIG. 1;

FIG. 3 is an enlarged view of a side elevation of an armature of the electromagnetic actuator of the engine mount of FIG. 1;

FIG. 4 is an enlarged view in cross section of a plastic deformation member of the engine mount of FIG. 1, taken along line 4-4 of FIG. 5;

FIG. 5 is a top plane view of the plastic deformation member of FIG. 4;

FIG. 6 is a graph demonstrating relationship between load and deformation of actual measurements when the plastic deformation member is subjected to pressing force;

FIG. 7 is a view showing a state wherein an actuating rod is assembled within an armature with a given inclination;

FIG. 8 is an elevational view in axial or vertical cross section of an automotive engine mount of construction according to a second embodiment of the present invention;

FIG. 9 is an enlarged view in cross section of a plastic deformation member of the engine mount of FIG. 8, corresponding to FIG. 4 of the first embodiment;

FIG. 10 is a cross sectional view of an electromagnetic actuator of an automotive engine mount according to another embodiment of the present invention;

FIG. 11 is a top plane view of the electromagnetic actuator of FIG. 10;

FIG. 12 is a cross sectional view of an electromagnetic actuator of an automotive engine mount according to yet another embodiment of the present invention;

FIG. 13 is a top plane view of the electromagnetic actuator of FIG. 12;

FIG. 14 is a cross sectional view of an electromagnetic actuator of an automotive engine mount according to still yet another embodiment of the present invention;

FIG. 15 is a top plane view of the electromagnetic actuator of FIG. 14;

FIG. 16 is a cross sectional view of an electromagnetic actuator of an automotive engine mount according to a further embodiment of the present invention;

FIG. 17 is a cross sectional view of an electromagnetic actuator of an automotive engine mount according to a yet further embodiment of the present invention; and

FIG. 18 is a top plane view of the electromagnetic actuator of FIG. 17.

### DETAILED DESCRIPTION OF PREFERRED EMBODIMENTS

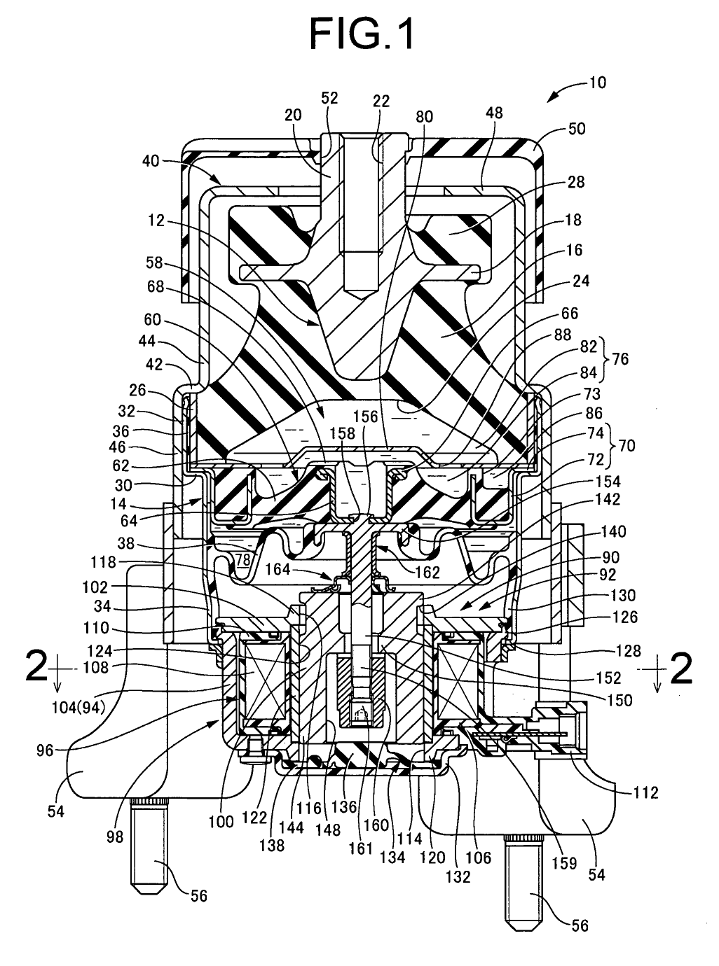

Referring first to FIG. 1, there is shown a fluid filled type active vibration damping device in the form of an automotive engine mount 10 of construction according to a first embodiment of the present invention. The engine mount 10 includes a metallic first mounting member 12 and a metallic second mounting member 14, which are positioned in opposition and spaced apart from each other, and elastically connected by means of a main rubber elastic body 16 interposed between them. With the first mounting member 12 attached to a power unit (not shown) and the second mounting member 14 attached to an automobile body (not shown), the power unit is supported on the body in a vibration-damped manner via the engine mount 10. In this installed state, the distributed load of the power unit is exerted on the engine mount 10, across the first mounting member 12 and the second mounting member 14 in the mounting center axis direction, which is the vertical direction in FIG. 1, whereby the main rubber elastic body 16 undergoes elastic deformation in the direction bringing the first mounting member 12 and the second mounting member 14 closer together. The principle vibrations to be damped are also input across the first mounting member 12 and the second mounting member 14, in the directions urging the two mounting members 12, 14 closer together/apart. In the description hereinbelow, unless indicated otherwise, vertical direction refers to the vertical direction in FIG. 1.

To describe in greater detail, the first mounting member 12 has an inverted frustoconical shape. At the large-diameter end of the first mounting member 12, there is integrally formed an annular disk shaped flange portion 18 that projects out on the outer peripheral face. Additionally, an integral fastening shaft 20 projects axially upward from the large-diameter end, with a fixation-tapped hole 22 that opens onto the upper end face is formed in the fastening shaft 20. By means of a fastening bolt (not shown) screwed into this fixation-tapped hole 22, the first mounting member 12 is attached to the automobile's power unit, not shown.

To the first mounting member 12, there is bonded by vulcanization the main rubber elastic body 16. The main rubber elastic body 16 has a generally frustoconical shape overall, with a diameter gradually increasing as it goes axially downwardly. The first mounting member 12 is inserted into the small-diameter end of the main rubber elastic body 16, and bonded therewith by vulcanization. A center recess 24 of generally inverted mortar shape is formed open in the large diameter end face of the main rubber elastic body 16. Further, a metallic sleeve 26 is disposed about and bonded by vulcanization to the outer circumferential surface of the large-diameter end portion of the main rubber elastic body 16. That is, the main rubber elastic body 16 is formed as an integrally vulcanization molded product incorporating the first mounting member 12 and the metallic sleeve 26. A cushion rubber 28 is provided on the upper face of the flange portion 18 of the first mounting member 12, and integrally formed with the main rubber elastic body 16.

The second mounting member 14 has a thin-walled large-diameter, generally cylindrical shape. A shoulder portion 30 is formed in the axially medial portion of the second mounting member 14. To either side of this shoulder portion 30, the side axially above constitutes a large-diameter section 32, while the side axially below constitutes a small-diameter section 34. An inner circumferential surface of the large-diameter section 32 of the second mounting member 14 is covered by a thin seal rubber layer 36 vulcanization bonded thereto. A diaphragm 38 consisting of a thin rubber film which has a generally disk shape imparted with slack is disposed as a flexible film, in proximity to the lower open end of the small-diameter section 34; by means of vulcanization bonding the outer peripheral edge portion of the diaphragm 38 to the inner circumferential surface of the small-diameter section 34 of the second mounting member 14. With this arrangement, the lower open end (i.e. the small-diameter section 34 side) of the second mounting member 14 is provided with fluid-tight closure by means of the diaphragm 38.

The large-diameter section 32 of the second mounting member 14 is disposed about the metallic sleeve 26 bonded onto the outer circumferential surface of the large-diameter end portion of the main rubber elastic body 16, and is firmly fixed thereto by press fitting or by being subjected to a drawing operation or the like. Thus, the second mounting member 14 is fixed to the integrally vulcanization molded product of the main rubber elastic body 16 composed of the first mounting member 12 and the metallic sleeve 26. With this arrangement, the first mounting member 12 and the second mounting member 14 disposed coaxially while being spaced apart from each other in the axial direction (the vertical direction in FIG. 1) in which is input a primary vibrational load to be damped, and elastically connected together by means of the main rubber elastic body 16. With the large-diameter section 32 of the second mounting member 14 fixed onto the main rubber elastic body 16, the axial upper (i.e. the large-diameter section 32 side) opening of the second mounting member 14 is provided with fluid-tight closure by the main rubber elastic body 16.

A stopper metal sleeve 40 is disposed outwardly and fixed onto the second mounting member 14 from the axially upper side. The stopper metal sleeve 40 is of a large-diameter stepped tubular shape, and has a positioning shoulder 42 at axially intermediate portion. To either side of this positioning shoulder 42, the side axially above constitutes a small-diameter section 44, while the side axially below constitutes a large-diameter section 46. This stopper metal sleeve 40 includes an abutting portion 48 integrally formed at its axially upper end, having a form of an inward flange. The large-diameter section 46 of the stopper metal sleeve 40 is radially outwardly disposed and firmly fixed onto the large-diameter section 32 of the second mounting member 14, with the positioning shoulder 42 superposed on an upper end face of the metallic sleeve 26, whereby the stopper metal sleeve 40 is assembled with the integrally vulcanization molded product of the main rubber elastic body 16 while being positioned in the axial direction. With this assembled state, the abutting portion 48 and the cushion rubber 28 are opposed to each other with a given axial spacing interposed therebetween so that the flange portion 18 of the first mounting member 12 comes into contact in the axial direction with the abutting portion 48 in a cushioning manner via the cushion rubber 28. This arrangement provides a rebound stopper mechanism for limiting the axial displacement of the first mounting member 12 relative to the second mounting member 14.

Axially above the stopper metal sleeve 40, there is formed a bound stopper rubber 50 with a given axial spacing therebetween. The bound stopper rubber 50 is of an inverted cup shape overall, and has a through hole 52 perforated through the radially central portion of its roof portion. The fastening shaft 20 of the first mounting member 12 is inserted through the through hole 52 with an inner circumferential surface of the through hole 52 bonded onto the outer circumferential surface of the fastening shaft 20, whereby the bound stopper rubber 50 is fixed to the first mounting member 12. With this arrangement, the relative displacement between the first and second mounting members 12, 14 in the axially and mutually approaching direction can be limited by means of cushion-wise abutting contact between the surface of the roof portion of the bound stopper rubber 50 and the abutting portion 48, thereby providing a bound stopper mechanism in the present embodiment. In the present embodiment, the bound stopper rubber 50 is disposed for covering the upper portion of the small-diameter section 44 of the stopper metal sleeve 40.

On an outer circumferential surface of the axially lower end portion of the stopper metal sleeve 40, there is fixed a plurality of fixation legs 54 extending axially downward, to which a plurality of fixation bolts 56 are fixed, respectively. With the fixation bolts 56 screwed into an automotive body side member (not shown), the second mounting member 14 is fixed to the automotive body via the stopper metal sleeve 40.

Between the opposing faces of the main rubber elastic body 16 and the diaphragm 38 in the second mounting member 14 interior, there is formed a fluid chamber 58 that constitutes a sealed zone fluid-tightly isolated from the outside, with a non-compressible fluid being sealed therein. As the non-compressible fluid sealed therein, there may be employed water, an alkylene glycol, a polyalkylene glycol, silicone oil, or the like. In order to effectively achieve vibration damping action on the basis of fluid flow action, a low-viscosity fluid of 0.1 Pa·s or less will be employed, preferably.

A partition member 60 is assembled within the fluid chamber 58 so as to extend in the axis-perpendicular direction, while being supported by the second mounting member 14.

The partition member 60 has a support rubber elastic body 62 extending in the axis-perpendicular direction with a predetermined thickness, and an oscillation member 64 is bonded by vulcanization to the center portion of this support rubber elastic body 62. The oscillation member 64 is of an inverted cup shape, and is bonded by vulcanization at its entire outside peripheral edge to the inside peripheral edge of the support rubber elastic body 62. The oscillation member 64 includes a flange portion in the form of a reinforcing flange 66 integrally formed by bending its opening edge portion radially outwardly. This reinforcing flange 66 is subjected to a rolling operation so that the radially outer peripheral portion is folded back with an arcuate shape in the radially inward direction. This arrangement is effective to prevent cracking in the support rubber elastic body 62, even if burrs are formed at peripheral edge of the reinforcing flange 66. On the upper face of the reinforcing flange 66, the support rubber elastic body 62 has extended with a relatively large thickness, thereby providing a cushioning portion 68.

An outer peripheral fitting 70 is bonded by vulcanization to the outside peripheral edge of the support rubber elastic body 62, and a grooved portion 72 being open upwardly and extending a predetermined distance in the circumferential direction is formed in the outer peripheral fitting 70. A flange 74 is also integrally formed at an opening edge portion of an outside wall of the grooved portion 72 so as to extend outwardly in the axis-perpendicular direction. The outer peripheral portion of the support rubber elastic body 62 is bonded by vulcanization to an inside wall of the grooved portion 72 in the state that the support rubber elastic body 62 extends into and fills the inside of the grooved portion 72. On the upper side of the support rubber elastic body 62 filling the inside of the grooved portion 72, there is formed a circumferential groove 73 opening upward and extending circumferentially with a length smaller than the circumference of the grooved portion 72.

A partition plate 80 of metal is superposed on the support rubber elastic body 62 from the above. This partition plate 80 has a generally round disk shape, and is directly superposed on the flange 74 of the outer peripheral fitting 70 at its outer peripheral portion. Both outer peripheral portions of the superposed partition plate 80 and the flange 74 are superposed on the shoulder portion 30 of the second mounting member 14, and compressed by and between the shoulder portion 30 and the metallic sleeve 26 that is fitted into the second mounting member 14.

With this arrangement, the partition member 60 is disposed between axially opposite faces of the main rubber elastic body 16 and the diaphragm 38, while spreading in the axis-perpendicular direction, thereby dividing the fluid chamber 58 within the second mounting member 14 into two parts on the axially both sides thereof. Namely, on the axially upper side of the partition member 60, there is formed a pressure-receiving chamber 76 whose wall is partially defined by the main rubber elastic body 16 and generates a fluid pressure fluctuation based on the elastic deformation of the main rubber elastic body 16 upon input of vibrational load. On the axially lower side of the partition member 60, there is formed an equilibrium chamber 78 whose wall is partially defined by the diaphragm 38 and having a variable volume. As will be understood from the aforementioned explanation, the pressure-receiving chamber 76 is composed at one wall part of the main rubber elastic body 16, and at another wall part of the partition member 60. Within this pressure-receiving chamber 76, there is disposed the oscillation member 64 with attached in a displaceable fashion in the axial direction with respect to the second mounting member 14 via the support rubber elastic body 62.

In this assembled state, the partition plate 80 is axially upwardly spaced away from the center area of the support rubber elastic body 62, which is located radially inside of the outer peripheral fitting 70. Thus, the pressure-receiving chamber 76 is divided into two parts on the axially both sides of the partition plate 80. Namely, on the axially upper side of the partition plate 80, there is formed a working fluid chamber 82 whose wall is partially defined by the main rubber elastic body 16, while on the axially lower side of the partition plate 80, there is formed an excitation chamber 84 whose wall is partially defined by the oscillation member 64. In this embodiment, the partition plate 80 has an axially upward projection at its radially center portion, whereby the radially central portion of the partition plate 80 is axially upwardly spaced away form the radially central region of the partition member 60.

The outer peripheral portion of the partition plate 80 is tightly contact on the upper face of the outer peripheral portion of the support rubber elastic body 62 that fills the grooved portion 72 of the outer peripheral fitting 70, whereby the opening of the circumferential groove 73 is tightly closed by the outer peripheral portion of the partition plate 80, thus providing a tunnel-shaped passage extending circumferentially with a length smaller than the circumference of the grooved portion 72. This tunnel-shaped passage is connected at one end to the working fluid chamber 82 via a communication hole (not shown) formed through the partition plate 80, and at the other end to the equilibrium chamber 78 via a communication hole (not shown) formed through the bottom wall of the grooved portion 72. Thus, by utilizing this tunnel-shaped passage, there is formed an orifice passage 86 for a fluid communication between the pressure-receiving chamber 76 and the equilibrium chamber 78. This orifice passage 86 may have a desirable passage length and cross sectional area, depending upon the required damping capability. In this embodiment, for example, the orifice passage 86 is tuned to exhibit damping effect with respect to a low frequency vibration such as engine shake at around 10 Hz. Accordingly, upon input of low frequency and large amplitude vibration, the non-compressible fluid is forced to flow through the orifice passage 86 between the both chambers 76, 78, thereby exhibiting passive damping effect based on resonance of the fluid flowing through the first orifice passage 86. Alternatively, the one end of the orifice passage 86 may be connected to the excitation chamber 84 via a communication hole formed through the inside wall of the grooved portion 72.

The partition plate 80 includes a plurality of perforated holes 88 formed on its radially intermediate portion at respective circumferential locations. Via these perforated holes 88, the working fluid chamber 82 and the excitation chamber 84 are held in mutual communication.

Axially below the second mounting member 14, i.e. on the opposite side of the oscillation member 64 remote from the pressure-receiving chamber 76, there is disposed an electromagnetic oscillator 90 serving as a solenoid operated actuator. This electromagnetic oscillator 90 is fixed to the second mounting member 14.

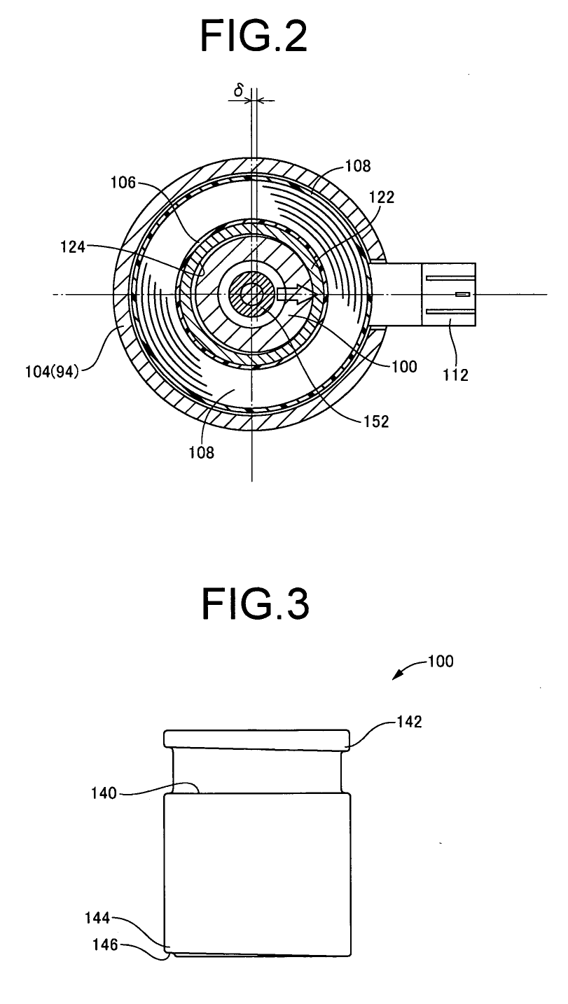

As illustrated in FIGS. 1 and 2, the electromagnetic oscillator 90 includes a solenoid actuator 92, and a housing 94 supporting the solenoid actuator 92 housed therein. More specifically, the solenoid actuator 92 is composed of a stator including a magnetic pole forming member 98 comprising a coil member 96, and an armature 100 serving as a movable element of thick walled generally round disk shape, positioned so as to be capable of relative displacement in the axial direction with respect to the coil member 96. In this embodiment in particular, the housing 94 is not a separate independent member. Instead, a lower yoke 104 that constitutes part of the magnetic pole forming member 98 serves as the housing 94.

The magnetic pole forming member 98 is composed of the coil member 96, and an upper yoke 102 and the lower yoke 104 which are attached about the perimeter of the coil member 96. Additionally, the coil member 96 has a coil 108 wrapped around a bobbin 106, with a cover member 110 of nonmagnetic material disposed covering the outside periphery of the coil 108. This cover member 110 has integrally formed therein a power supply opening 112 which projects to the outside from an opening made through the lower yoke 104, and power is supplied to the coil 108 via a terminal disposed within the power supply opening 112. The driving voltage having frequency components supplied to the coil 108 is not limited to alternating current, with pulsating current being acceptable as well, and control is not limited to analog, but may be digital instead.

The lower yoke 104 which serves as the housing 94 has a lower through-hole 114 made in the center portion thereof, and is formed with an “L” shaped cross section extending substantially all the way around the circumference so as to enclose the outer circumferential surface and the lower end face of the coil member 96. The upper yoke 102 is disposed on the upper end face of the coil member 96. The upper yoke 102 is formed with a general disk shape having an upper through-hole 116 of diameter dimension approximately equal to the lower through-hole 114 of the lower yoke 104, with the edge on the inner circumferential side being made somewhat thicker, while the edge on the outer circumferential side is positioned covering the coil member 96, in a state of contact with the upper end of the lower yoke 104. The upper yoke 102 and the lower yoke 104 are constituted as yoke members formed of ferromagnetic material, constituting a stationary side magnetic path through which flows magnetic flux produced by supply of current to the coil 108, while the inside peripheral edge portions of the upper through-hole 116 and the lower through-hole 114 respectively constitute an upper magnetic pole 118 and a lower magnetic pole 120 serving as magnetic pole forming areas where the magnetic poles form when current is supplied to the coil 108.

Within the center hole of the coil 108 constituting the stator, there is installed a guide sleeve 122 arranged so as to cover the openings at the upper and lower inside peripheral edge portions formed by the upper yoke 102 and the lower yoke 104. In this embodiment, the stator is composed to include this guide sleeve 122, and the center hole of the guide sleeve 122 constitutes a tubular guide face 124 serving as a guide hole. That is, the tubular guide face 124 of the guide sleeve 122 is constituted as a tube shaped face slightly smaller in diameter than the magnetic pole inside faces of the upper yoke 102 and the lower yoke 104, and is positioned slightly inward in the diametrical direction from the magnetic pole inside faces of the upper and lower yokes 102, 104. This guide sleeve 122 will preferably be formed of a non-magnetic material, e.g., stainless steel in this embodiment. Alternatively, the guide sleeve 122 may be formed of rigid synthetic resin materials such as polyethylene or polytetrafluoroethylene, or other non-magnetic materials such as aluminum alloy and austenitic high manganese steels. Low-friction materials are suitably used for the guide sleeve 122. The guide sleeve 122 may be fixed with respect to the upper and lower yokes 102, 104, elastically supported, or installed with somewhat of a gap. That is, it suffices for the guide sleeve 122 to smoothly guide the armature 100 in the axial direction, while preventing it from interfering with the upper and lower yokes 102, 104, etc.

On the upper edge portion of the housing 94, there is incised an mating groove 126. A detent piece 128 formed on the lower end of the second mounting member 14 fits into this mating groove 126 and is detained by caulking therein, whereby the magnetic pole forming member 98 of the electromagnetic oscillator 90 is attached so as to cover the lower end opening of the second mounting member 14. In this embodiment, the electromagnetic oscillator 90 is fastened directly to the second mounting member 14 without interposing any bracket or other separate element, thus reducing positioning deviation of the center axes of the oscillation member 64 and the coil 108 during assembly. Since a clamped rubber element 130 formed by extending the diaphragm 38 downward is clamped between the housing 94 of the electromagnetic oscillator 90 and the second mounting member 14, chatter of the electromagnetic oscillator 90 is prevented. With this arrangement, the center axis of the coil 108 is substantially aligned with the center axis of the engine mount 10, and coincident with the center axes of the second mounting member 14 and the oscillation member 64.

A cover member 132 is bolted to the bottom of the housing 94, to prevent dust and the like from infiltrating into the lower through-hole 114 of the housing 94. Further, an elastic stopper 134 is disposed between the lower end inner peripheral edge of the housing 94 and the cover member 132. The cover member 132 has a generally round disk-like shape overall, and includes a thick walled portion serving as a stopper rubber 136 at its central portion, and an thin walled portion serving as a sealing rubber 138 at its outer peripheral portion. This sealing rubber 138 is compressed by and between the lower yoke 104 and the cover member 132, thereby providing a fluid-tight sealing at this portion.

The armature 100 is assembled within the lower through-hole 114 of the housing 94 in which the coil 108 has been installed. The armature 100 is formed of a ferromagnetic body of generally cylindrical block shape overall, having an outside diameter dimension that is slightly smaller than the inside diameter dimension of the guide sleeve 122. The armature 100 is assembled fitting within the guide sleeve 122 so as to be capable of relative displacement in the axial direction, in an approximately coaxial manner. Additionally, the armature 100 has an axial length dimension that spans the upper and lower magnetic poles 118, 120. In proximity to the upper magnetic pole 118 thereof, there is formed a circumferential groove 140 that opens in the outer circumferential surface. The axial upper end portion and lower end portion of the armature 100 serve as an upper magnetic action part 142 and a lower magnetic action part 144, respectively, which constitute annular magnetic action areas extending entire circumference. As illustrated, for example, magnetic gaps at which effective magnetic attracting force is excited are formed in an appropriate position, between the upper magnetic action part 142 and the upper magnetic pole 118 of the upper yoke 102, and between the lower magnetic action part 144 of the armature 100 and the lower magnetic pole 120 of the lower yoke 104. The outside circumferential surface of the armature 100 is subjected to a low friction treatment or anticorrosion treatment with any of various coating materials known in the art.

As illustrated in FIG. 3, the widthwise dimension of the circumferential groove 140 of the armature 100 varies in the circumferential direction, so that the axial position of the lower end face of the upper magnetic action part 142 varies in the circumferential direction. Further, the armature 100 includes at its lower end a stepped portion 146 whose height dimension varies in the circumferential direction, so that the axial position of the lower end face of the lower magnetic action part 144 varies in the circumferential direction. In short, the lower end face of the upper magnetic action part 142 and the lower end face of the lower magnetic action part 144 are both inclined with respect to the axis-perpendicular direction. The inclination of the both lower end faces of the upper magnetic action part 142 and the lower magnetic action part 144 are made similar in the same circumferential position. As will be apparent form the foregoing description, the lower end portion of the upper magnetic action part 142 (opening edge portion of the circumferential groove 140) and the lower end portion of the lower magnetic action part 144 serve as annular edge portions, in the present embodiment.

The inclined lower end face of the upper magnetic action part 142 and the inclined lower end face of the lower magnetic action part 144 vary in the circumferential direction a space distance between the upper magnetic pole 118 and the lower magnetic pole 120, and vary in the circumferential direction a space distance between the upper magnetic action part 142 and the lower magnetic action part 144. In the present embodiment, the upper end corner of the inner circumferential surface of each of the upper magnetic pole 118 and the lower magnetic pole 120 as well as the lower end corner of the outer circumferential surface of each of the upper magnetic action part 142 and the lower magnetic action part 144 are dominant to the generated magnetic force, since these corners of the upper magnetic pole 118 and the lower magnetic pole 120 are most closely located with respect to the armature 100 in a static state. Then, an axial space distance between these corners varies in the circumferential direction. More specifically, the space distance between the both corners changes in the circumferential direction at a period of 360 degrees in the circumferential direction, so that one circumferential position where the both corners are located closest to each other, and another circumferential position where the both corners are located nearest to each other and another circumferential position where the both corners are located farthest to each other, are opposed to each other in one axis-perpendicular direction.

This arrangement makes uneven in the circumferential direction the magnetic attractive force in the axial direction acting between the upper and lower magnetic poles 118, 120 and the armature 100 (upper and lower magnetic action parts 142, 144). As a result, the armature 100 is subjected to the force that is biased in one axis-perpendicular direction indicated by the arrow in FIG. 2, whereby the armature 100 is displaced by a given distance δ in the axis-perpendicular direction relative to the guide sleeve 122. In the present embodiment, by means of the displacement of the armature 100 relative to the guide sleeve 122, the outer circumferential surface of the armature 100 is forcedly pressed onto the tubular guide face 124 of the guide sleeve 122 in the one axis-perpendicular direction. This arrangement, namely, constitute a magnetic force biasing mechanism (or a bias urging assembly). Alternatively, in the one axis-perpendicular direction in which the resultant force of the magnetic attractive force acts to the armature 100, the armature 100 may be held in non-contact state, i.e. may be slightly spaced away from the tubular guide face 124 of the guide sleeve 122, or alternatively the armature 100 may be held in a line contact against the tubular guide face 124 over its entire axial length. In the present embodiment, the armature 100 is brought into abutting contact with the tubular guide face 124 over the entire axial length. FIG. 2 exaggeratedly shows the deviation of the armature 100 relative to the guide sleeve 122 in the axis-perpendicular direction.

A through hole 148 is formed as a mating hole, bored through the center axis in the armature 100. An inward protruding portion 150 is formed in the axially medial portion of this through hole 148, and to either side of the inward protruding portion 150, the diameter dimension of the through hole 148 is made smaller on the axially upper side rather than the axially lower side.

An actuating rod 152 serving as a connecting shaft is passed through the through hole 148 of the armature 100 with a gap to allow some displacement. This actuating rod 152 has a shaft body shape extending in the axial direction, and is fixed at its upper end portion to the oscillation member 64, while having a flange shaped fixation part 154 integrally formed at its axially intermediate portion. This fixation part 154 is superposed onto the bottom wall of the oscillation member 64 from the axially lower side with its outer peripheral portion bonded to the radially central portion of the diaphragm 38. A caulking part 156 is formed at the upper end of the actuating rod 152, and inserted into a fixation hole 158 formed through the bottom wall portion of the oscillation member 64. By caulking this caulking part 156 against the oscillation member 64, the actuating rod 152 is firmly fixed to the oscillation member 64.

The lower end of the actuating rod 152 projects downward beyond the inward protruding portion 150 of the armature 100. On this projecting lower end of the actuating rod 152, a thread, thereby constituting a bolt thread portion 159. To the lower end of the actuating rod 152 serving as the bolt thread portion 159, there is screwed up a lock-up nut 160 having an outside diameter larger than an inside diameter of the inward protruding portion 150. Further, a set screw 161 is tighten on the lower side of the central bore of the lock-up nut 160. With this arrangement, the actuating rod 152 is supported by the armature 100 in a manner for preventing the actuating rod 152 from being dislodged from the armature 100 in the axially upward direction. By tightening the lock-up nut 160, the oscillation member 64 (partition member 60) and the armature 100 are forcedly pressed in a mutually approaching direction in an axis direction of the actuating rod 152, thereby being relatively positioned in the axial direction. That is, the lock-up nut 160 serves as a positioning mechanism in the present embodiment. The stopper rubber 136 is disposed axially below the actuating rod 152 with a given distance therebetween, and is adapted to come into cushion-wise abutment against the lower end of the actuating rod 152, thereby constituting a stopper mechanism for preventing excess displacement of the actuating rod 152 in the axially downward direction.

On the actuating rod 152 on the opposite side of the inward protruding portion 150 from the lock-up nut 160, there is externally fitted a tubular spacer member 162 and a plastic deformation member 164, while being located between axially opposite upper end face of the armature 100 and the lower end face of the of the fixation part 154 of the actuating rod 152.

The spacer member 162 is of a generally round tubular member with an inside diameter slightly larger than an outside diameter of the actuating rod 152. The spacer member 162 is externally fitted onto the axially medial portion of the actuating rod 152. Axially opposite ends of the spacer member 162 have a radially outwardly curved shape in axial cross section with a diameter gradually increases. More specifically, the axially upper end of the spacer member 162 is held in abutting contact with the lower end face of the fixation part 154 of the actuating rod 152, while the axially lower end of the spacer member 162 is held in abutting contact with the upper end face of the plastic deformation member 164. This tubular spacer member 162 is formed of a material having a substantial rigidity, preferably is selected from metallic materials like a stainless steel, or high rigid synthetic resin materials. In the present embodiment, the spacer member 162 is a rigid member formed of a stainless steel.

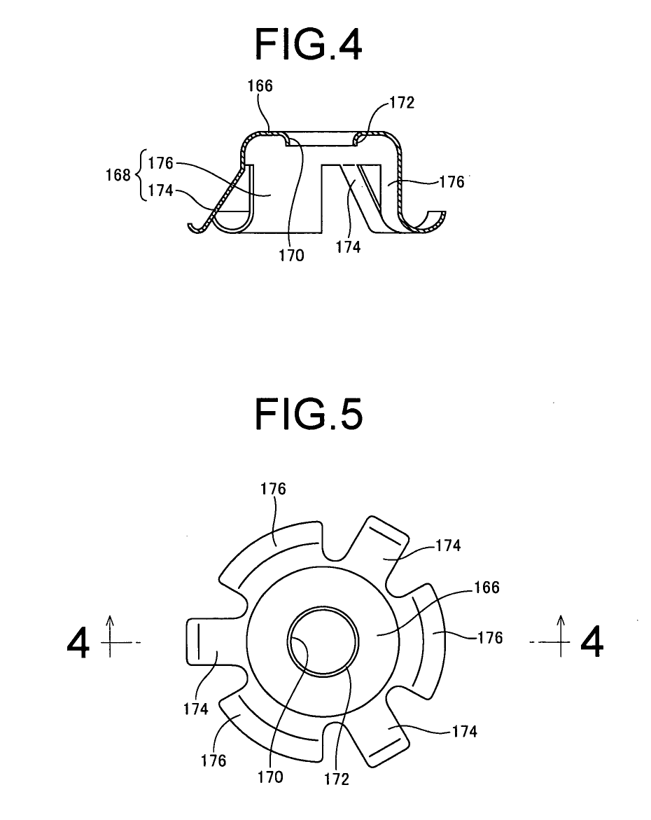

The plastic deformation member 164 is disposed between the lower end portion of the spacer member 162 and the upper end face of the armature 100, while being externally fitted onto the actuating rod 152. More specifically, as shown in FIGS. 4 and 5, the plastic deformation member 164 includes a top wall portion 166 and a plurality of leg portions 168.

The top wall portion 166 is of an annular disk-like shape, and has a through hole 170 perforating its central portion for an insertion of the actuating rod 152. At the inner rim of the top wall portion 166, there is integrally formed a positioning tubular portion 172 projecting axially outwardly along with the actuating rod 152, over an entire circumference thereof. In this embodiment, the positioning tubular portion 172 is externally fitted onto the actuating rod 152, whereby the plastic deformation member 164 is fixed onto the actuating rod 152 in an externally mounted state. Alternatively, the positioning tubular portion 172 is formed at the inner rim of the top wall portion 166 so as to extend axially upwardly or in the axially both directions.

At the outer rim of the top wall portion 166, there is integrally formed the plurality of leg portions 168. These leg portions 168 are located at respective circumferential positions on the outer rim of the top wall portion 166, while extending axially downward therefrom, and are held in contact at their extending ends with the upper end face of the armature 100. These leg portions 168 consist of inclined legs 174 having a generally rectangular flat plate shape overall while extending diagonally outwardly downward with respect to the axial direction, and stopper legs 176 extending in the axial downward direction with a curved plate shape with a wide given circumferential length. Lower end portions of the inclined legs 174 and the stopper legs 176 are curved with a radially outward curl shape so that both inclined legs 174 and the stopper legs 176 are superposed on the upper end face of the armature 100 at parts of their curved end portions located at axially lowest portion of the plastic deformation member 164. Distal ends of the lower end portions of the inclined legs 174 and the stopper legs 176 are located axially slightly above the upper end face of the armature 100 so as not to be contact with the upper end face of the armature 100. As shown in FIG. 5, three inclined legs 174 and three stopper legs 176 are formed in the present embodiment, while being arranged in a alternate fashion in the circumferential direction. Circumferentially adjacent inclined legs 174 and the stopper legs 176 are spaced away from one another with a given circumferential intervals, thereby providing gaps between the inclined legs 174 and the stopper legs 176 in the circumferential direction.

The spacer member 162 and the plastic deformation member 164 are externally fitted onto the actuating rod 152 with a state mutually superposed in the axial direction, while disposed between the lower end face of the fixation part 154 of the actuating rod 152 and upper end face of the armature 100, which faces opposed in the axial direction.

On the lower end of the actuating rod 152, the lock-up nut 160 is tightened, by means of a torque applied thereto, whereby the lower end face of the fixation part 154 and the upper end face of the armature 100 come close to each other in the axial direction. As a result, axial compression force acts on the spacer member 162 and the plastic deformation member 164. Since the spacer member 162 is made of thick walled metallic material and has a high rigidity in comparison with the plastic deformation member 164, while the plastic deformation member 164 has the plurality of leg portions 168 of shapes readily deformable, the plastic deformation member 164 will undergo deformation due to this axial compression force. In the present embodiment, the load concentration will be likely to occur at a boundary between the top wall portion 166 and the leg portions 168.

By tightening the lock-up nut 160 sufficiently, the plastic deformation member 164 further undergoes plastic deformation. Thus, the fixation part 154 of the actuating rod 152 and the armature 100 are positioned relative to each other in the axially approaching direction, by means of the spacer member 162 and the plastic deformation member 164.

The actuating rod 152 and the armature 100 are positioned relative to each other in the axial direction by a combination between the lock-up nut 160 and the plastic deformation member 164. The actuating rod 152 extends through the through hole 148 of the armature 100 in a displaceable fashion, while being forcedly clamped between axially opposite faces of the lock-up nut 160 and the plastic deformation member 164. With this arrangement, the actuating rod 152 is assembled with respect to the armature 100 while being displaceable relative to the armature 100 in the axis-perpendicular direction.

While the coating layer is applied on the outer circumferential surface of the armature 100, which is adapted to slidable contact with the guide sleeve 122, the same low-friction processing, e.g., an application of a coating layer is also provided on a part of the armature 100, which serves to permit axis-perpendicular displacement of the actuating rod 152 relative to the armature 100. Described in detail, the coating layer is applied at least on an axially upper end face of the armature 100 as well as an axially lower end face of the inward protruding portion 150 of the armature 100. Alternatively, a coating layer may be applied on an entire surface of the armature 100. In the present embodiment, a resin coating using a low-friction resin material is applied as a low-friction processing or a rust proofing treatment on the outer circumferential surface of the armature 100, the axially upper end face of the armature 100, and the axially lower end face of the inward protruding portion 150.

With this arrangement, a pair of slidable-contact faces extending in the axis-perpendicular direction of the armature 100 are formed on the axially upper end face of the armature 100 on which the plastic deformation member 164 is superposed and on the axially lower end face of the inward protruding portion 150 on which the lock-up nut 160 is superposed. Thus, the plastic deformation member 164 and the lock-up nut 160 are made readily displaceable relative to the armature 100 by means of the respective slidable-contact faces.

Therefore, the oscillation member 64 and the armature 100 are connected together via the actuating rod 152 while being relatively positioned in the axial direction, and being displaceable relative to each other in the axis-perpendicular direction.

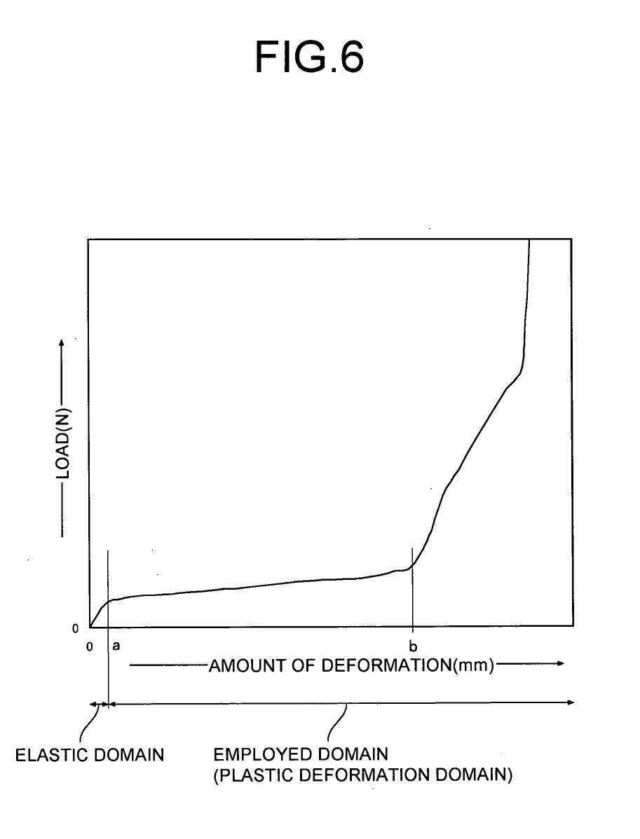

FIG. 6 shows a graph demonstrating relationship between load and deformation of actual measurements when the plastic deformation member 164 is subjected to pressing force. The plastic deformation member 164 is deformed until its amount of deformation reaches to an employed domain, i.e. “a mm” or more in FIG. 6, whereby the actuating rod 152 and the armature 100 are fixedly positioned relative to each other in the axial direction by the plastic deformation member 164 which has been deformed as stated above. It should be appreciated that the aforementioned amount of deformation of the plastic deformation member 164 is determined by way of example, it may be appropriately determined depending upon the size and material of the plastic deformation member 164, a predictable external load exerted on the actuating rod 152 and the armature 100, or the like.

In the present embodiment, the plastic deformation member 164 has an elastic deformation domain with an amount of deformation smaller than a mm in the compression direction where the free length in the axial direction is made 0. Preferably, the plastic deformation member 164 may be disposed in a state of being deformed with an amount of plastic deformation domain with an amount of deformation of a mm or more and not greater than b mm in the axial direction. As will be understood from FIG. 6, the plastic deformation domain represent a deformation domain where a deformation occurs excess a yield point (e.g. a point of a mm in FIG. 6) so that the plastic deformation member 164 will not return to an initial non-deformed state even after the application of load is released.

While not shown in the drawing, in the engine mount 10 having the construction described above, it is possible to control current flow to the coil 108. This control of current flow can be accomplished, for example, by means of adaptive control or other feedback control, using the engine ignition signal of the power unit as a reference signal and the vibration detection signal of the component being damped as an error signal, or on the basis of control data established in advance for a map control. With this arrangement, by producing magnetic force acting on the armature 100 to actuate it downward in the axial direction, and then halting current flow to the coil 108 and allowing the recovery force of the support rubber elastic body 62 to act, it becomes possible to subject the oscillation member 64 to actuating force which corresponds to the vibration being damped. Thus, achieve active vibration damping action by internal pressure control of the pressure-receiving chamber 76.

In the engine mount 10 of this embodiment, the upper magnetic action part 142 and the lower magnetic action part 144 of the armature 100 are made of mutually parallel inclined surfaces. Thus, the axial distance between the armature 100 and the upper magnetic pole 118 or the lower magnetic pole 120 varies in the circumferential direction. As a result, magnetic attractive force exerted on the armature 100 varies in the circumferential direction, whereby the resultant force of the axis-perpendicular-directed magnetic force component of magnetic force acting on the armature 100 is produced in one direction in the axis-perpendicular direction where a distance between the upper and lower magnetic action parts 142, 144 and the upper and lower magnetic poles 118, 120 become shortest.

By means of this arrangement, the magnetic force acting in one direction is exerted on the upper and lower ends of the armature 100 (upper and lower magnetic action parts 142, 144), so that tilting of the armature 100 can be reduced. By means of reducing tilting of the armature 100, point contact of the armature 100 with the upper or lower yoke 102, 104 or with the guide sleeve 122 which causes an increase of a contact pressure or sticking can be reduced or avoided, thereby improving operational stability, and ensuring improved durability by preventing uneven wear of the components. Additionally, this arrangement protects any coating layer on the armature 100 so that the low-friction sliding characteristics or corrosion resistance afforded by the coating layer will be exhibited consistently for an extended period.

In this embodiment, the bias urging assembly is provided by effectively utilizing magnetic force generated by the solenoid type actuator, making it possible to realize a desired deviation biasing mechanism with the reduced number of components and simple construction. Since the bias urging assembly utilizes a magnetic force generated with the coil 108, avoiding a problem of change over time such as fatigue thereof, permitting a stable provision of desired characteristics for a long period of time.

Further, the actuating rod 152 is assembled with the armature 100 while being mutually positioned in the axially approaching direction or twisting direction by means of a combination between the spacer member 162, the plastic deformation member 164 and the lock-up nut 160. This makes it possible to effectively avoid damages caused by contact between the actuating rod 152 and the armature 100, while effectively transmitting the driving force in the axial direction produced by the armature 100 to the oscillation member 64.

It should be noted that since the actuating rod 152 is fixed to the armature 100 by screwing up the lock-up nut 160 until the plastic deformation member 164 is deformed with an amount of deformation reaching the plastic deformation domain, a force or moment produced by an inclination of the actuating rod 152 acting on the armature 100 are effectively reduced or eliminated.

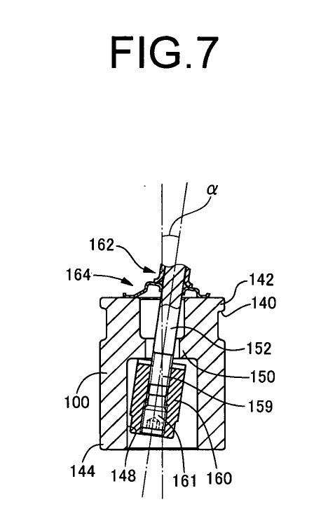

Namely, as a result of molding shrinkage of the support rubber elastic body 62, oscillation member 64 to which the actuating rod 152 is fixed may possibly inclines relative to the center axis of the armature 100. As shown in FIG. 7, the actuating rod 152 extends through the armature 100 with an inclined angle “α”. Further clarify purpose only, the inclined angle of the actuating rod 152 is exaggeratedly depicted in FIG. 7.

With the state shown in FIG. 7, the lock-up nut 160 threaded in the actuating rod 152 is screwed further. While the contact reaction forces of the lock-up nut 160 and the plastic deformation member 164 with respect to the armature 100 make the actuating rod 152 some what move to the armature 100 in a direction to be concentric, i.e., in the direction of reducing the inclined angle “α”, due to the elastic force generated by the support rubber elastic body 62, which supports the actuating rod 152, the actuating rod 152 is held in the inclined state with respect to the armature 100. Even if the actuating rod 152 is held in this inclined state, the plastic deformation member 164 can be deformed in an asymmetry inclined fashion. Thus, the plastic deformation member 164 can be held in abutment on the axially upper end face of the armature 100 at a plurality of portions on the circumference, whereby the actuating rod 152 is held in connection with the armature 100 with stability.

In particular, once the amount of deformation of the plastic deformation member 164 excess the elastic deformation domain (spring domain) and reaches the plastic domain, the plastic deformation member 164 will undergo plastic deformation in the asymmetry state corresponding to the inclined angle of the actuating rod 152 to the armature 100. Thus, the actuating rod 152 and the armature 100 are connected together in a mutually inclined state, making it possible to reduce or eliminate a force caused by an elasticity of the plastic deformation member 164 and acting between the actuating rod 152 and the armature 100 for moving two members relative to each other to be concentric.

In the plastic deformation member 164 which has undergone deformation in the plastic deformation domain, the leg portions 168 (the inclined leg 174 and the stopper leg 176) located in the lateral direction as seen in FIG. 7 (i.e., the axis-perpendicular direction in which the actuating rod 152 inclined) are forcedly held on the axially upper surface of the armature 100 with a generally even axial pressing force. This arrangement makes it possible to reduce or eliminate moments acting between the actuating rod 152 and the armature 100 in the twisting direction. In other words, this arrangement is able to effectively prevent inclination of the armature 100 with respect to the axial direction.

Therefore, irrespective of the inclination of the actuating rod 152 with respect to the axial direction, the armature 100 can be disposed into the guide sleeve 122 (axial direction) with no inclination, so that the armature 100 can be displaced in the axial direction relative to the guide sleeve 122 with high stability, and without scratching or local contacts. Thus, the armature 100 is free from or less likely to be worn out or damaged by means of this prevention of point or local contact of the armature 100 against the guide sleeve 122, thereby enhancing durability of the armature 100 effectively. Where the actuating rod 152 is assembled with the armature 100 in the axially inclined state as illustrated in FIG. 7, the actuating rod 152 will be excited in the axial direction of the engine mount 10 while being inclined with respect to the axial direction. Thus, upon exciting the actuating rod 152, unstable swinging motion of the actuating rod 152 or the like can be effectively prevented.

Further, since the spacer member 162 is disposed with superposed on the plastic deformation member 164 in the axial direction, an axial distance between the fixation part 154 and the armature 100 can be suitably adjusted by changing the axial dimension of the spacer member 162, while obtaining a given stroke for deformation of the plastic deformation member 164.

Since the plastic deformation member 164 includes the top wall portion 166 and the plurality of leg portions 168, it is possible to make the top wall portion 166, which is superposed on the spacer member 162 in the axial direction, highly rigid so as to effectively realize axial positioning between the oscillation member 64 and the armature 100, while making the leg portions 168 readily deformation. In addition, since the leg portions 168 includes the inclined legs 174, where the axial pressing force acts on the plastic deformation member 164, the inclination of the plastic deformation member 164 with respect to the actuating rod 152 is effectively prevented, permitting stable plastic deformation of the plastic deformation member 164 in the axial direction.

Furthermore, three inclined legs 174 are arranged at a uniform interval in the circumferential direction, while the three stopper legs 176 are also arranged at a uniform interval in the circumferential direction while being located between adjacent ones of the inclined legs 174, respectively. Thus, where the axial pressing force acts on the plastic deformation member 164, it can be held in the initial fixation state with stability without being inclined. Further, gaps are formed between adjacent leg portions 168, thereby providing air vent passage. Thus, air chambers formed on the axially opposite sides of the armature 100 are held in communication via the through hole 148 of the armature 100 and the passage formed by the gaps between the leg portions 168. This arrangement makes it possible to prevent generation of air spring by the air chambers on the both sides of the armature 100, which may possibly prevent excitation or deformation of the armature 100.

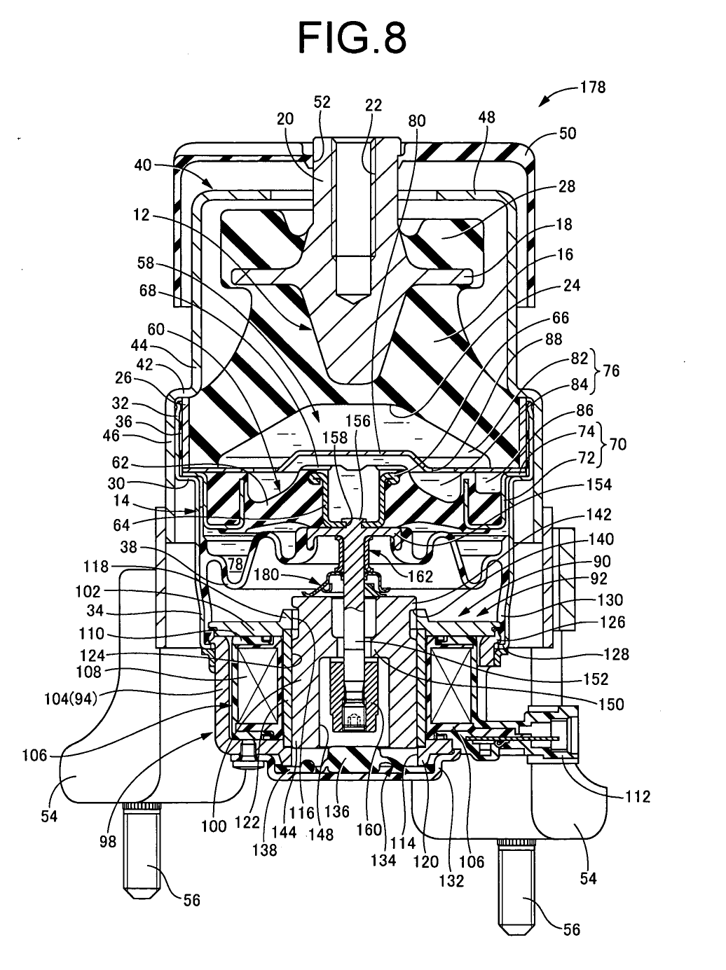

Referring next to FIG. 8, there is shown an automotive engine mount 178 of construction according to a second embodiment of the present invention. In the following explanation, the same reference numerals as used in the illustrated embodiment are used for identifying structurally and functionally corresponding elements, to facilitate understanding of the instant embodiment.

In the engine mount 178 of construction according to the present embodiment, a plastic deformation member 180 is disposed between axially opposite faces of the fixation part 154 of the actuating rod 152 and the armature 100. The plastic deformation member 180 includes a top wall portion 166 of generally annular plate shape, and a plurality of inclined legs 174 and stopper legs 182 extending axially downwardly from the outside rim of the top wall portion 166. In this embodiment, only the inclined legs 174 are held in abutting contact with the upper end face of the armature 100, while the stopper legs 182 are axially upwardly spaced away from the upper end face of the armature 100.

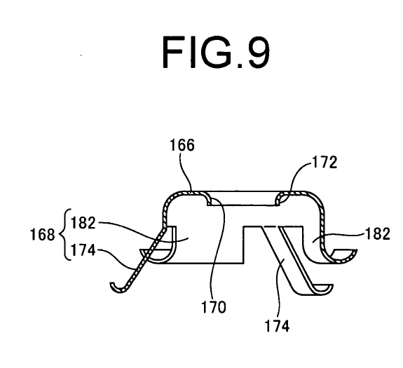

More specifically depicted in FIG. 9, the inclined legs 174 have a generally rectangular flat plate shape overall, and extends diagonally outwardly downward from the outside rim of the top wall portion 166. A curve is provided on the projecting distal end of each of the inclined legs 174, so that the curved portion of the inclined leg 174 provides an abutting end face that is held in abutting contact with the axially upper end face of the armature 100, and the distal end of the inclined leg 174 is slightly spaced away from the upper end face of the armature 100 in the axially above direction.

On the other hand, the stopper legs 182 are also integrally formed at respective circumferential locations on the top wall portion 166 (three locations in the present embodiment), and extend in the axially downward direction with a curved plate shape curving in the circumferential direction of the top wall portion 166. Each stopper leg 182 has a circumferential width dimension sufficiently larger than a widthwise dimension of each inclined leg 174. An axially lower end of each stopper leg 182 is curved outside, so that a part of the curved portion serving as an abutting end face is located in the lowest portion of the stopper leg 182, while the distal end of the stopper leg 182 is slightly located axially above the lowest portion of the stopper leg 182. The axially lowest portion of the stopper leg 182 (lowest portion of the curved portion) is located axially above the axially lowest portion of the inclined leg 174, thereby being axially spaced away by a given distance from the upper end face of the armature 100 in the axially upward direction.

In the engine mount 178 of construction according to the present embodiment, where the lock-up nut 160 is screwed up in order to apply an axial pressing force on the plastic deformation member 180, the inclined legs 174 of the plastic deformation member 180 are plastically deformed. When the inclined legs 174 undergoes plastic deformation in excess of a given amount, the lower ends of the stopper legs 182 come into contact with the upper end face of the armature 100. Since each stopper leg 182 has an extending dimension smaller than each inclined leg 174, the stopper leg 182 has a high rigidity than the inclined leg 174. Therefore, by means of the abutting contact of the stopper legs 182 against the armature 100, there is provided a stopper mechanism for limiting displacement between the fixation part 154 and the armature 100 toward each other in excess of a given amount. Thus, the fixed positioning between the fixation part 154 and the armature 100 in the axially approaching direction can be effectively provided. By the presence of the stopper legs 182, after the plastic deformation of the plastic deformation member 180, the fixation part 154 and the armature 100 can be positioned with an approximately constant axial spacing therebetween, without variation. Thus, the distance between the armature 100 and the stator (upper and lower magnetic poles 118, 120) can be set without variation, whereby give oscillation characteristics can be stably exhibited.

While the present invention has been described in detail in its presently preferred embodiment, for illustrative purpose only, it is to be understood that the invention is by no means limited to the details of the illustrated embodiment, but may be otherwise embodied.

For instance, in the illustrated first and second embodiments of the present invention, the magnetic force biasing mechanism consisting the bias urging assembly can be realized by forming the lower face of the upper and lower magnetic action parts 142, 144 as inclined surfaces inclined with respect to the axis-perpendicular direction for varying the distance between the upper and lower magnetic action parts 142, 144 and the upper and lower magnetic poles 118, 120. The deviation biasing mechanism may be otherwise embodied, but not limited to the illustrated embodiments. There will be described yet another embodiment of the present invention having a deviation biasing mechanism whose construction is different from those of the mechanisms in the illustrated first and second embodiments.

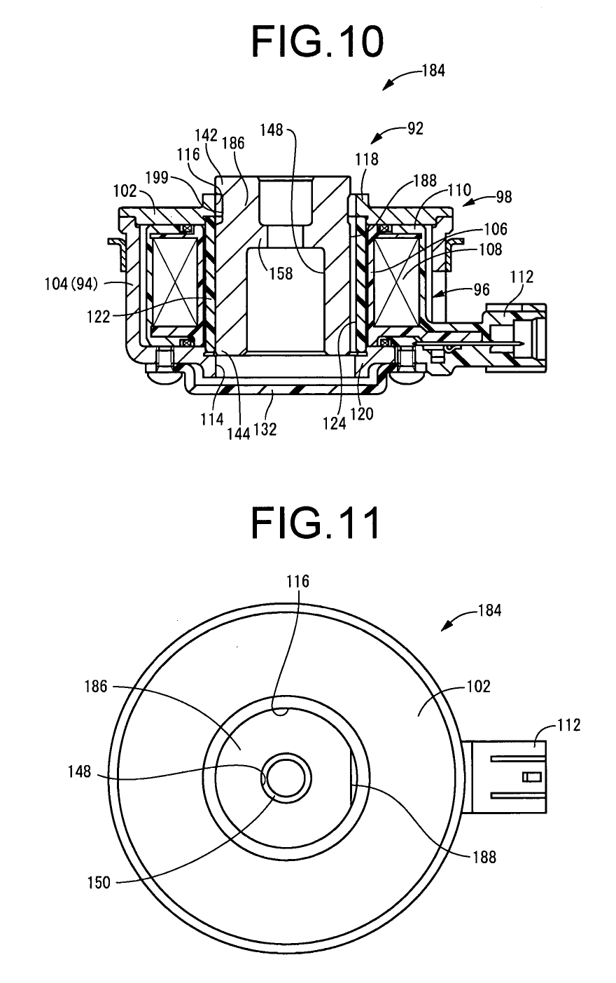

For instance, FIG. 10 and FIG. 11 illustrate an electromagnetic oscillator 184 having an axial groove 188 extending over the entire axial direction of the armature 186 at one circumferential position. In one axis-perpendicular direction where the axial groove 188 is positioned, the axis-perpendicular distance between the armature 186 and the upper and lower magnetic poles 118, 120 is maximized for reducing the magnetic force generated therebetween, thereby providing a magnetic force biasing mechanism.

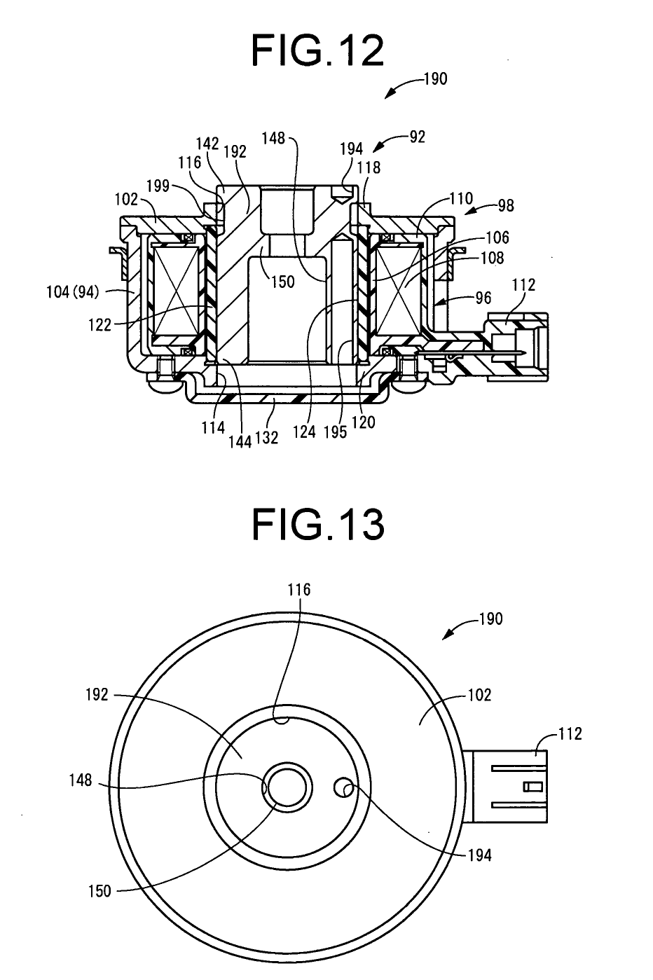

FIGS. 12 and 13 shows an electromagnetic oscillator 190 wherein an upper weight reducing hole 194 and a lower weight reducing hole 195 are formed to an armature 192. By means of forming upper and lower weight reducing holes 194, 195 in the armature 192, the zones permitting passage of lines of magnetic force differ along the circumference of the armature 192. It is possible thereby to vary in the circumferential direction the number of lines of magnetic force flowing through the armature 192, to generate in one direction in the circumferential direction, a resultant force of the magnetic force components acting in the axis-perpendicular direction, thereby providing a magnetic force biasing mechanism. Other than by forming the upper and lower weight reducing holes 194, 195, the number of lines of magnetic force can vary in the circumferential direction by forming grooves or through holes with the same effect.

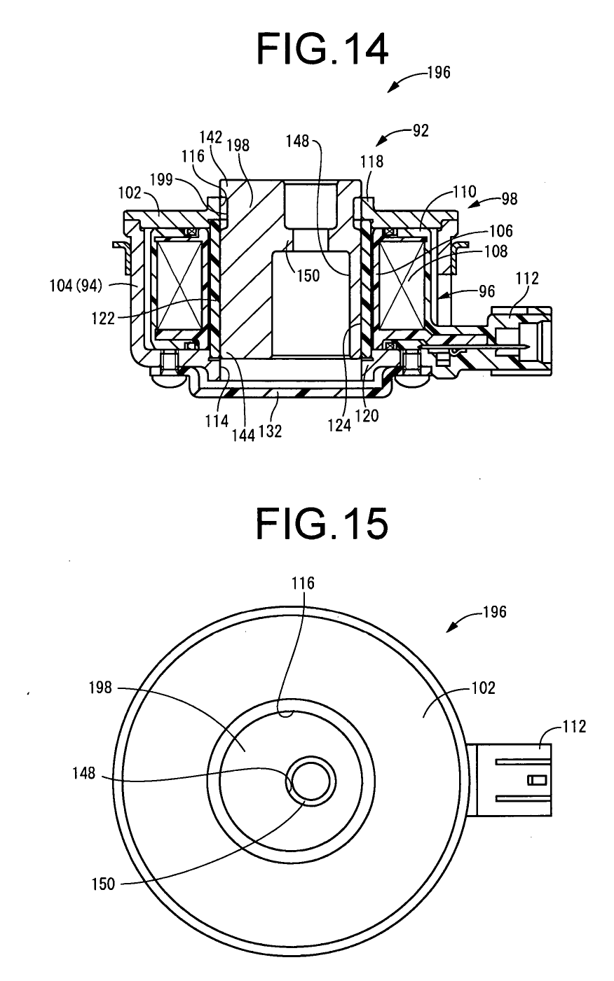

FIG. 14 and FIG. 15 show an electromagnetic oscillator 196 wherein the through hole 148 of an armature 198 is formed at an eccentric location. By means of this arrangement, the number of lines of magnetic force flowing through the armature 198 can be varied in the circumferential direction, thereby providing a magnetic force biasing mechanism.

It should be noted that these armatures 186, 192 and 198 each has a circumferential groove 199 whose both side walls are parallel to each other so that the circumferential groove 199 has a generally constant widthwise dimension over its entire circumference.

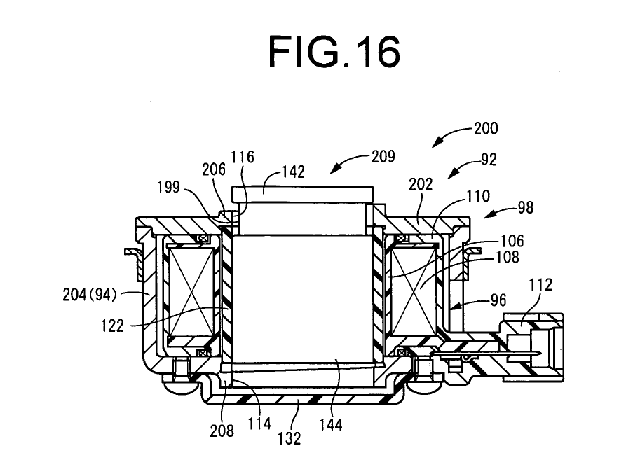

Alternatively, the magnetic force biasing mechanism can be realized by changing the shapes of the upper and lower yokes. More specifically, FIG. 16 shows an electromagnetic oscillator 200 wherein an upper and lower magnetic poles 206, 208 of the upper and lower yokes 202, 204 are formed by inclined faces inclining with respect to upper end faces of an upper magnetic pole 206 and a lower magnetic pole 208, which upper end faces spread in the axis-perpendicular direction. By means of this arrangement, a magnetic force biasing mechanism is also embodied, for example. In this electromagnetic oscillator 200, an armature 209 has a circumferential groove 199 whose both side walls extend in the axis-perpendicular direction.

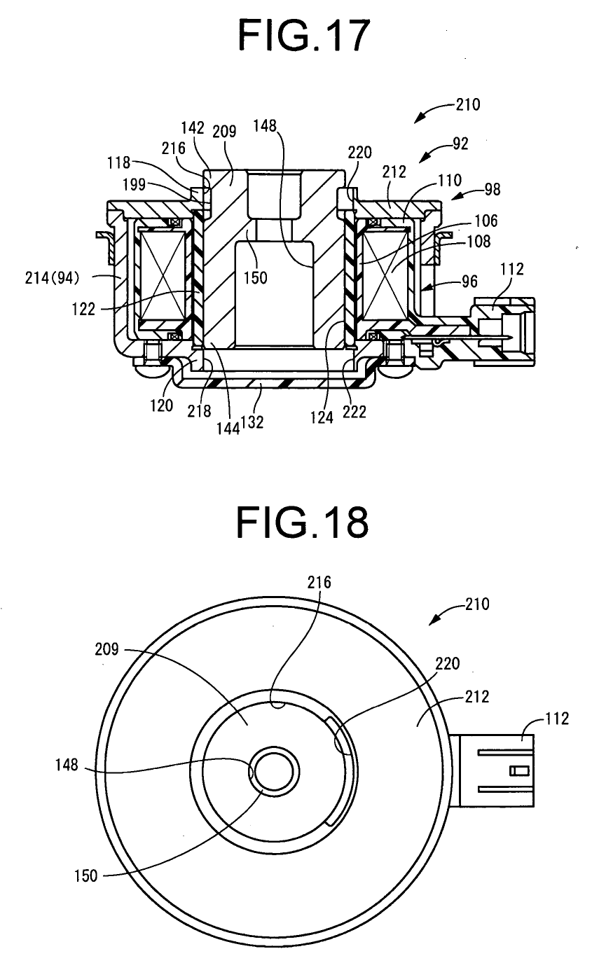

FIG. 17 and FIG. 18 show an electromagnetic oscillator 210, wherein the upper yoke 212 and the lower yoke 214 have upper and lower through holes 216, 218, respectively, and these upper and lower through holes 216, 218 have upper and lower expanding parts 220, 222 where their diameters are increased. These upper and lower expanding parts 220, 222 are located on the same circumferential position so that they are opposed to each other in the axial direction. By means of this arrangement, the distance separating the upper and lower magnetic poles 118, 120 and the upper and lower magnetic action parts 142, 144 varies in the circumferential direction, thereby providing a magnetic force biasing mechanism.

The magnetic force biasing mechanism is not limited to the forms discussed above, and may take other forms, for example, by forming the movable element (armature) from a combination of materials having different magnetic permeabilities, to cause the magnetic force acting on the movable element to vary in the circumferential direction. Alternatively, a combination of a plurality of magnetic force biasing mechanisms may also be employable. Further, the magnetic force biasing mechanism may be incorporated both in the movable element and stator.

While the magnetic force biasing mechanism is employed as a bias urging assembly in the first and second embodiments, it would be possible to employ another mechanism as the bias urging assembly. For instance, a spring mechanism utilizing a permanent magnet, a rubber elastic body or the like may be employed as a bias urging assembly. As in the first and second embodiments, the spring mechanism may be incorporated in the solenoid actuator 92, or in the other components. More specifically, the bias urging assembly may be provided on the vibration damping device body to which the solenoid actuator 92 is attached. Alternatively, a bias urging assembly for exhibiting biasing force in the axis-perpendicular direction may be provided on an oscillation member of the vibration damping device or a connecting rod (actuating rod) fixed to the oscillation member.

A tubular spacer formed independent of the plastic deformation member is not necessary for practicing the present invention. Therefore, the plastic deformation member may directly abut on the upper end face of the armature 100 and the lower end face of the fixation part 154, so as to be disposed between these upper and lower end faces in the axial direction. The shape of the tubular spacer is not limited to the one illustrated in the first and second embodiments, but may have a possible variation. The tubular spacer may have a stepped tubular shape with an intermediate step portion, or alternatively may have a slit, a hole, or the like. In the first and second embodiments, the spacer member 162 is formed of a stainless steel, but it may be formed of a variety of materials having a required rigidity. For instance, a rigid synthetic resin material may be employed as a material for the tubular spacer.

The plastic deformation member is not necessarily formed of a metallic material such as a stainless steel, but may be formed of a rigid synthetic resin material.

In order to ensure both of sufficient deformability and shape stability in the plastic deformation member, the plastic deformation member includes the top wall portion 166 and the leg portions 168 in the first and second embodiments. This construction is preferably, but not essential. For instance, the plastic deformation member may have a tubular shape extending in the axial direction, and is held in abutting contact at its upper end with the fixation part 154 and at its lower end with the upper end face of the armature 100, while being provided with a plurality of slits for making its deformation easy at a plurality of locations on the circumference.

The plastic deformation member is not necessarily provided with the inclined legs 174 and the stopper legs 176. For instance, all the leg portions may be formed by the inclined legs 174 extending diagonally.

It is also to be understood that the present invention may be embodied with various other changes, modifications and improvements, which may occur to those skilled in the art, without departing from the spirit and scope of the invention defined in the following claims.

What is claimed is:

1. A fluid-filled type active vibration damping device comprising:
a first mounting member and a second mounting member, the members attachable respectively to components linked to each other to make up a vibration transmission system;
a main rubber elastic body elastically connecting the first and second mounting members, defining one portion of a wall of a pressure-receiving chamber having a non-compressible fluid sealed therein;
an oscillation member defining another portion of the wall of the pressure receiving chamber;
a solenoid actuator including a stator having a coil and a yoke member attached about the coil to form a stator-side magnetic path with a guide hole extending along a center axis thereof, and a movable element positioned inserted into the guide hole of the stator so that actuating force in an axial direction is created between the stator and the movable element by means of supplying electrical current to the coil, the stator of the solenoid actuator being affixed to the second mounting member and the movable element being attached to the oscillation member so as to actively control pressure in the pressure-receiving chamber by exciting actuation of the oscillation member;
a bias urging assembly for urging the movable element in one direction orthogonal to the center axis with respect to the stator;
a connecting shaft for connecting the movable element and the oscillation member while permitting their relative displacement in an axis-perpendicular direction;
a positioning mechanism for pressing and positioning the movable element and the oscillation member relative to each other in a mutually approaching direction in an axial direction of the connecting shaft; and
a plastic deformation member disposed between opposing faces of the movable element and the oscillation member, and being adapted to be deformed in a plastic deformation region exceeding an elastic deformation domain so as to define approaching ends of the movable element and the oscillation member in the mutually approaching direction so that the plastic deformation member in cooperation with the positioning mechanism fixedly position the movable element and the oscillation member in the axial direction.

2. A fluid-filled type active vibration damping device according to claim 1, wherein the bias urging assembly comprises a magnetic force biasing mechanism for biasing to one side in the axis-perpendicular direction a resultant force of magnetic forces excited in the axis-perpendicular direction between the movable element and the stator, by means of supplying electrical current to the coil.

3. A fluid-filled type active vibration damping device according to claim 2, wherein an annular magnetic pole portion is formed on an inner peripheral portion of the stator so as to extend over an entire circumference thereof, and an annular magnetic action part is formed on an outer peripheral portion of the movable element so as to extend over an entire circumference thereof, while being opposite to the annular magnetic pole portion of the stator with a gap therebetween both in axial and diametrical direction, and wherein the magnetic force biasing mechanism is realized by varying in a circumferential direction a distance between the magnetic pole portion and the magnetic action part.

4. A fluid-filled type active vibration damping device according to claim 3, wherein the movable element has an outer circumferential surface of cylindrical shape, and an annular edge portion of rectangular shape in cross section extends over an entire circumference on a plane slant to a plane orthogonal to a center axis of the outer circumferential surface of the movable element so that the magnetic action part is formed by means of the annular edge portion.

5. A fluid-filled type active vibration damping device according to claim 1, wherein the movable element has a through hole perforating therethrough in the axial direction, and the connecting shaft extends through the through hole while being fixed at one axial end thereof to the oscillation member, and being formed with a bolt thread at an other axial end thereof, while a positioning nut is threaded onto the bolt thread of the connecting shaft so that the positioning mechanism is realized by means of tightening up the positioning nut against the movable element.

6. A fluid-filled type active vibration damping device according to claim 1, further comprising a tubular spacer member that is axially superposed against the plastic deformation member, and together with the plastic deformation member is disposed radially outward of the connecting shaft, while being interposed between the opposing faces of the oscillation member and the movable element.

7. A fluid-filled type active vibration damping device according to claim 1, wherein the plastic deformation member is of an annular plate shape extending in the axis-perpendicular direction, and includes a top wall portion externally fitted on the connecting shaft and a plurality of inclined legs located on respective circumferential positions of the top wall portion while extending from an outer rim of the top wall portion toward axially one side with an inclination in an diagonally outward direction, the plastic deformation member undergoing plastic deformation at the inclined legs.

8. A fluid-filled type active vibration damping device according to claim 7, wherein the plastic deformation member further includes a positioning tubular portion extending in the axial direction from an inner rim of the top wall portion thereof so that the plastic deformation member is externally fitted on the connecting shaft at the positioning tubular portion.

9. A fluid-filled type active vibration damping device according to claim 7, wherein the plastic deformation member further includes a plurality of stopper legs located on respective circumferential positions of the top wall portion circumferentially interposed between adjacent ones of the inclined legs while extending from the outer rim of the top wall portion toward a same axially one side as the inclined legs parallel to the center axis.

10. A fluid-filled type active vibration damping device according to claim 9, wherein each of the plurality of stopper legs has an extending dimension smaller than each of the inclined legs so that the stopper legs have a high rigidity than the inclined legs.

11. A fluid-filled type active vibration damping device according to claim 1, wherein the oscillation member has a hollow cylindrical shape with bottom, and a support rubber elastic body is bonded on an outer circumferential surface of the oscillation member so that the oscillation member is supported by the support rubber elastic body in a displaceable manner relative to the second mounting member in the axial direction, while an open end edge of the oscillation member is bent toward the outer circumferential surface thereof with a roll shape.
